(19) United States
(12) Patent Application Publication
(10) Pub. No.: US 2011/0087613 A1
(43) Pub. Date: Apr. 14, 2011

(54) System and Method for Evaluating Supplier Quality

(75) Inventors: Douglas LaPasta, Hawley, PA (US); Marc Yanoff, Upper Black Eddy, PA (US); Joyce Herlihy, Rutherford, NJ (US); Andrew Grilk, Rockaway, NJ (US); Steven Cole, Lake Ariel, PA (US)

(73) Assignee: EVENDOR CHECK, INC., Hawley, PA (US)

(21) Appl. No.: 12/899,145

(22) Filed: Oct. 6, 2010

Related U.S. Application Data
(60) Provisional application No. 61/249,732, filed on Oct. 8, 2009.

(51) Int. Cl. G06Q 99/00

(52) U.S. Cl. 705/347

(57) ABSTRACT

Supplier evaluation system for selecting a supplier for a project and/or monitoring a current supplier's performance. A supplier evaluation system first comprises a first database storing a plurality of inquiries and supplier contact information. The supplier candidates identify raters and those raters receive the inquiries over a computer network. The system provides a user interface for the rater to confidentially respond to the inquiries. The raters' responses are then electronically sent to one or more databases in the system and the system's database management system analyses the responses and makes them available to purchasing agents in a plurality of formats.

### CROSS-REFERENCE TO RELATED APPLICATIONS

This application claims priority to U.S. provisional patent application No. 61/249,732, filed Oct. 8, 2009, which is incorporated herein by reference.

### STATEMENT REGARDING FEDERALLY SPONSORED RESEARCH

Not Applicable.

### BACKGROUND

1. Field of Invention

The present invention relates to systems and methods used to identify potential suppliers and analyze supplier capabilities, competence, quality, and past performance in order to make an informed selection/retention decision of a supplier, and more particularly to systems designed to perform due diligence on suppliers.

2. Description of Related Art

Supplier qualification is a process by which a group of suppliers of products and services are evaluated by a purchasing agent to determine at least one supplier that will qualify as a entity capable of providing a satisfactory product and/or level of service based upon predetermined objectives. For example, a typical project scenario may involve a government agency, utility company, telephone company, automotive manufacturer, or high-technology system integrator that desires to purchase a computer-based system, such as a new payroll accounting system. Alternatively, the project scenario may involve a manufacturer identifying a reliable long-term supplier of quality goods (e.g., the automotive industry relies on suppliers to provide millions of substantially defect-free parts every year according to exacting schedules to minimize parts inventory). Alternatively, the project scenario may involve a telecommunications company purchasing central office switches, voice mail systems, computer systems, video dial tone network elements, components for local loop distribution, etc.

An important consideration in supplier qualification is quality (i.e., a product and/or service free from defects) and reliability (i.e., a product and/or service having a relatively long mean time between failures). The efforts to minimize defects may in some instances be more important than the technical specifications of the product or service. For example, defects that arise in products used in the telecommunications industry may cause disastrous consequences when implemented as a critical component in an established telecommunications network. Thus, a purchasing agent will expend substantial efforts identifying suppliers able to provide products and services that meet the necessary reliability and quality standards of the relevant industry.

Supplier qualification typically involves the procedure of a purchasing agent identifying a set of technical and/or cost requirements that need to be met, compiling the technical and/or cost requirements, identifying suppliers who service the industry to which the technical and/or cost requirements relate, and selecting the supplier who can supply the needed product/service at the highest quality level and within the predetermined cost structure. After identifying suppliers who are capable of meeting the technical and/or cost requirements, the purchasing agent has a few options. The first, if available, is to select a supplier the purchasing agent has previous experience with. However, this particular option is often not available if the purchasing agent needs to procure a new product/service or finds the previously-used supplier to be of low quality or not able to offer competitive pricing. Moreover, in the case of a government purchasing agent, competitive bidding laws forbid the agent from simply selecting a formerly-used supplier.

Another option is to individually and directly contact other purchasing agents who are familiar with certain suppliers and obtain a rating regarding the supplier's ability to supply the needed products/services and the quality of such products/services. The problem with this option is the impossibility of spending the immense amount of time required to manually obtain a critical mass of such ratings within the required parameters for a given procurement project, the inability of the purchasing agent to verify the information provided by the rater, and the likelihood that the purchasing agent will not be able to obtain a rating for every supplier capable of meeting the technical and cost requirements. Moreover, clients of rated suppliers may not be fully candid about the negative aspects associated with a particular supplier for fear that the supplier may later become aware of the client's negative statements. In other words, the rater cannot be assured that his/her responses will be kept confidential by the purchasing agent. Accordingly, a purchasing agent cannot be sure of the legitimacy of any provided information, and given how limited the number of possible responses that may be contacted by phone is, the answers will not be statistically validated.

Another option would be for the purchasing agent to prepare a request for proposal or a request for quotation (RFP/RFQ) that is disseminated to the suppliers capable of meeting the technical and cost requirements, receiving and evaluating the RFP/RFQ responses from the suppliers, and selecting a supplier based upon the RFP/RFQ responses. One of the problems associated with this option is that the best suppliers may not reply to the RFP/RFQ, either because they don't receive it or they don't have time to fully answer it. In addition, the responses received for the RFP/RFQ may be difficult to compare. Suppliers may not all fully understand what is being requested in the RFP/RFQ, and therefore provide different information.

Constantly-increasing competitive pressures continue to drive business specialization while at the same time increasing the need for effective, efficient and reliable procurement and outsourcing. Accordingly, purchasing agents face escalating pressure and scrutiny as their responsibilities increase. Furthermore, firms today are outsourcing more and more of the critical components of their businesses, from manufacturing to payroll and customer service, and these trends show no sign of abating. Companies must be able to have confidence that outside suppliers who provide components or raw materials are honest and reliable. A wrong decision by a purchasing agent may not only eliminate the inherent benefits of the outsourcing process, but could negatively affect a firm's ability to build, ship, deliver and support its products and services.

There is therefore a need for a system and method that enables a purchasing agent to quickly, validly, and effectively evaluate supplier capabilities, quality, and reputation for purposes of selecting a supplier for a particular project. There is also a need for a system and method that will allow a purchasing agent to monitor and evaluate current suppliers' ongoing performance.

### SUMMARY

The present invention is directed to a novel system and method that satisfies the needs of enabling a purchasing agent to quickly, validly, and effectively evaluate supplier capabilities, as well as enabling the agent to monitor and evaluate current suppliers' ongoing performance. The present invention provides an method and system for quickly, validly, and effectively evaluating supplier capabilities, quality, and reputation in order to allow a purchasing agent to select a supplier for a project. According to the present invention, a purchasing agent accesses a user interface through an electronic network and selects or creates a supplier survey to be distributed to a plurality of supplier candidates. The user interface provides a choice of prewritten surveys as well as a menu of individual questions the purchasing agent can select to create a custom supplier candidate survey. The purchasing agent then identifies which supplier candidates will participate in the evaluation process. The system notifies the selected supplier candidates of their participation and provides instructions on how to access a second user interface. When the supplier candidates access the aforementioned interface, they are given specific instructions on how to input the names, addresses, and other contact information for a plurality of individual raters.

The system then distributes confidential surveys over an electronic network to the designated individual raters who rate the supplier candidates accordingly to various provided metrics. The individual raters may provide important information in their survey responses, including information regarding the supplier candidate's honesty, fairness, level of environmental compliance (i.e., the supplier candidate's “green credentials”), and commitment to workplace diversity. Moreover, the system comprises a method of encrypting individual raters' survey responses, thereby ensuring the confidentiality of such responses which incentivizes the individual raters to be candid in their survey responses.

The survey responses are then collected and stored in a second electronic database by a database management system (“DMS”), organized according to a plurality of predetermined categories, and analyzed by a central processing unit (“CPU”) using a pre-programmed algorithm. The purchasing agent can access the information on the database through a third user interface. The CPU and the DMS can then produce a variety of reports, comparison tables, guides, and spreadsheets as requested by the purchasing agent. The purchasing agent can also use the DMS to manipulate information stored in the database to better compare supplier candidates against one another. The purchasing agent can then use the produced information to make an informed procurement decision.

The present invention also provides a system for monitoring current supplier performance. A purchasing agent is able to update the information stored in the second database over time as selected suppliers perform their designated projects. As more information about a supplier is uploaded to the second database, the DMS and CPU allow the purchasing agent to create ongoing reports of the supplier's performance.

These and other features of the present invention will become readily apparent in view of the accompanying drawings and the detailed description of the embodiments.

### BRIEF DESCRIPTION OF THE DRAWINGS

FIG. 1 is a flow chart of a supplier evaluation system according to a preferred embodiment of the present invention.

FIG. 2 is a block diagram of a purchasing agent user interface according to certain embodiments of the present invention.

FIG. 3 is a block diagram of a supplier user interface according to certain embodiments of the present invention.

FIG. 4 is a block diagram of a rater user interface according to certain embodiments of the present invention.

### DETAILED DESCRIPTION

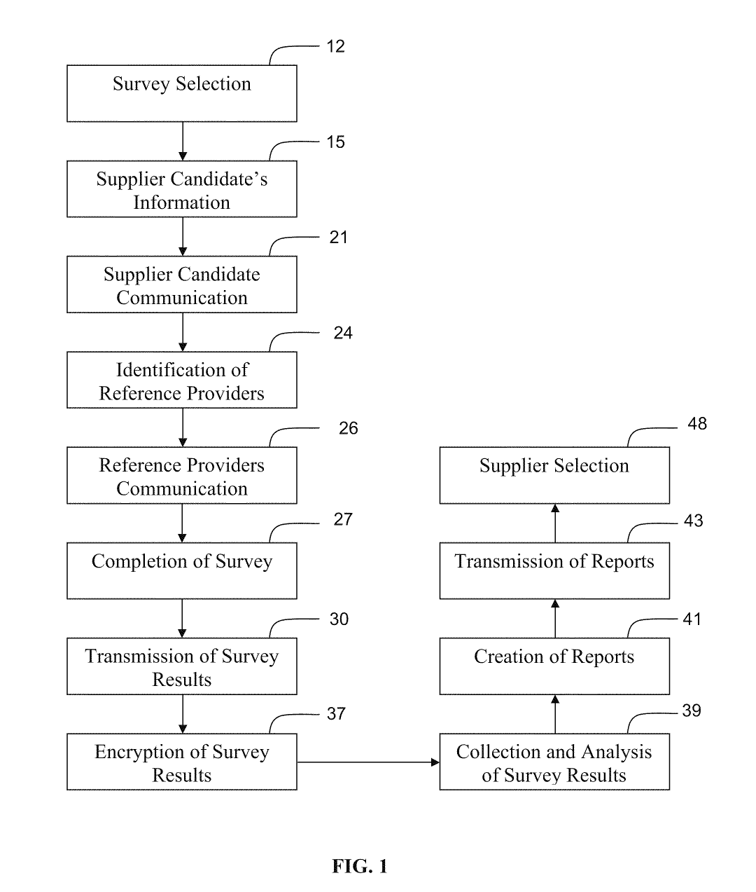

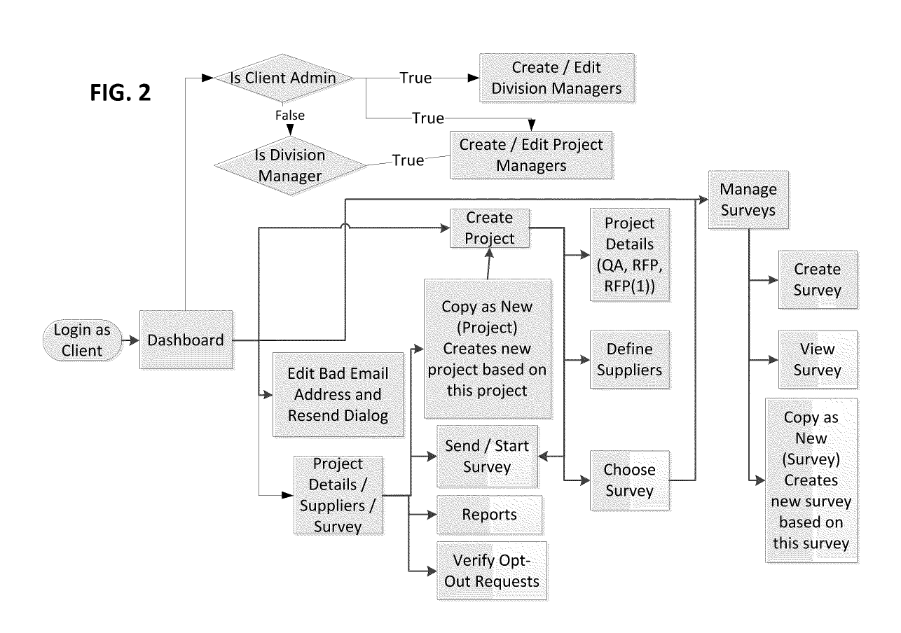

FIG. 1 is a flow diagram of a system and method for evaluating suppliers according to a preferred embodiment of the present invention. The present invention generally comprises the use of an electronic network to obtain and transmit information from raters about supplier candidates to purchasing agents who will make a decision regarding which supplier candidate to select and/or whether to retain a previously-used supplier. The process in FIG. 1 begins with the selection 12 of a survey by the purchasing agent via a first user interface. One example of the first user interface that may be employed as part of the present invention can be seen in block-diagram form in FIG. 2. Referring back to FIG. 1, the purchasing agent may select a pre-written survey, create a custom survey from a menu of provided questions, or draft his/her own questions. The questions are designed to obtain quantitative and qualitative information about supplier candidates. Once the purchasing agent has selected the survey in step 12, the process continues at step 15 wherein the purchasing agent inputs via the first user interface the contact information for each supplier candidate the purchasing agent is considering. The survey selected in step 12 and the contact information provided in step 15 are then stored in a first electronic database.

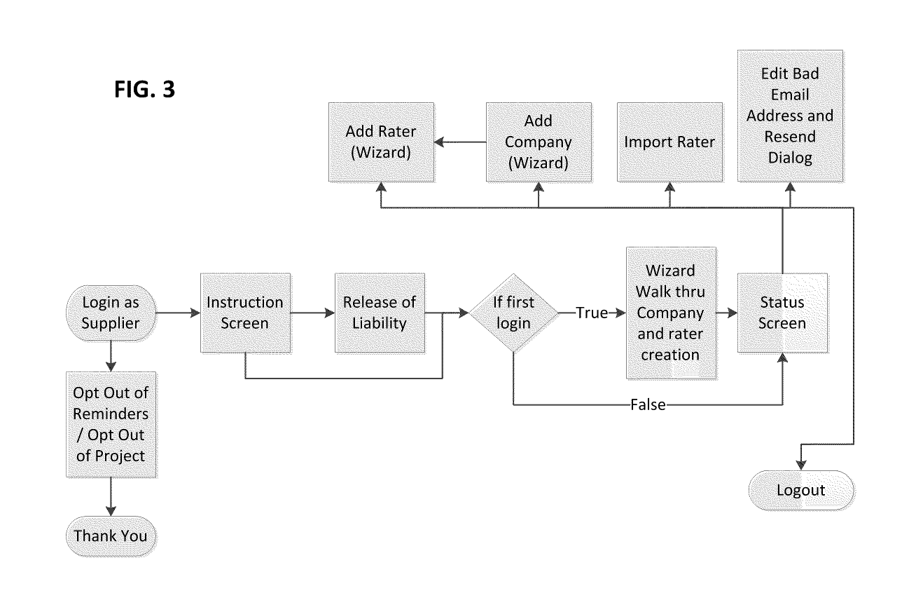

In step 21, the supplier candidate contact information is used to transmit the stored survey selected in step 12 over an electronic network to the supplier candidates. The supplier candidates receive an electronic communication that includes instructions on how to access a second user interface wherein the supplier candidates can identify raters. The supplier candidates then access the second user interface in step 24 via a computer connected to the electronic network and identify who their raters will be. One example of the second user interface that may be employed as part of the present invention can be seen in block-diagram form in FIG. 3. Typically, raters will be customers of a supplier candidate who are able to answer survey questions regarding how well the candidate performed the project the customer requested.

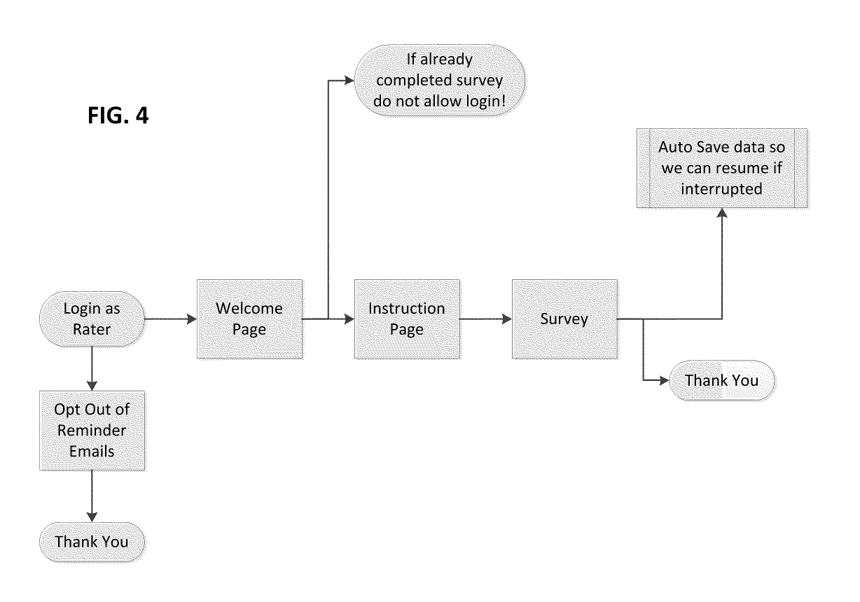

Once identified, the raters, referring back to FIG. 1, receive an electronic communication in step 26 from a database management system that includes instructions on how to access a third user interface wherein the raters can answer the survey questions. One example of the third user interface that may be employed as part of the present invention can be seen in block-diagram form in FIG. 4.

Referring back to FIG. 1, the system continues to step 27 whereby each rater uses the third user interface to access the survey stored in the first electronic database and complete said survey by answering the stated questions and entering information into a web-based form. The web-based form allows the raters to confirm information supplied by the supplied candidate (e.g., confirm when a particular project was performed for the rater). In preferred embodiments of the system, the system allows for the input of particular information to automatically trigger “follow-up” questions to obtain more specific information about the particular supplier candidate. For example, if a rater gave a low score regarding a supplier candidate's honesty, the system would automatically create a new question for the rater such as “Would you please explain why you provided this score for this provider?” Also in preferred embodiments of the system, the raters can identify additional raters that were not originally listed by the supplier candidate.

When complete, the survey responses are electronically and confidentially transmitted in step 30 to a second electronic database where they are stored. In step 37, the system encrypts all identifying information of the raters who transmit survey responses to ensure that supplier candidates are unable to determine a particular rater's responses to any survey.

In step 39, the system's database management system collects the survey responses stored on the second database, analyzes and processes that information based on a pre-programmed algorithm, and in step 41, creates reports, spreadsheets, comparison tables, and guides based on the processed information. The system then electronically transmits in step 43 the report, spreadsheet, comparison table, and/or guide to the purchasing agent, who can access the information through a fourth user interface.

In step 48, the purchasing agent may then use the report, spreadsheet, comparison table, and/or guide provided by the system to make informed supplier selection decisions. In preferred embodiments, the system permits the purchasing agent to add to and instantly compare all of the data collected for each supplier candidate by manipulating the plurality of databases maintained by the system's database management system. This allows the purchasing agent to create his/her own customized reports for each supplier candidate under consideration. The data-manipulation features of the system also allow for the creation of scaled scores from the collected raw data to better compare supplier candidates against one another (e.g., via side-by-side comparisons). The system also allows the purchasing agent to update the information in the databases for a selected supplier to monitor that supplier's performance over time. Finally, as the amount of data collected in the system's databases exponentially increases over time, the system allows for statistical validation of the data collected as well as allow a purchasing agent to perform a plurality of quantitative analysis techniques on the collected data, including the “screening” of potential suppliers as “in” or “out” of a “qualified supplier list.” In other preferred embodiments, the system automatically sends an electronic message to the purchasing agent some time after the purchasing agent has reviewed the generated analysis (e.g., 6 months) and asks the purchasing agent to identify which supplier was selected. This information is then added to the system's databases.

What is claimed is:

1. A supplier evaluation system to qualify a supplier for a project, said system comprising:
(a) a central processing unit;
(b) a database management system;
(c) a first electronic database storing a plurality of inquiries related to supplier competency and quality;
(d) a network-communication means for communicating electronic information;
(e) a first user interface wherein a customer may select from said inquiries and identify supplier candidates;
(f) a second user interface wherein said supplier candidates identify one or more raters:
(g) a third user interface wherein said plurality of inquiries stored in said first database are communicated to said raters via said network-communication means and said raters' responses to said plurality of inquiries are communicated to, via said network-communication means, and stored in said first database;
(h) said data processor compiling and converting said raters' responses to provide qualitative and quantitative analysis of a supplier based on said raters' responses;
(i) a means of separating said analysis from said raters' responses so that said raters' responses are kept confidential;
(j) a second database storing said analysis; and
(k) a forth user interface wherein said analysis stored in said second database is communicated to and manipulated by a customer.

2. The system of claim 1, wherein not all of said raters are selected by said customer.

3. The system of claim 1, wherein said plurality of inquiries are in a language other than English.

4. The system of claim 1, wherein said rater responses are in a language other than English.

5. The system of claim 1, wherein said database management system is further operable to provide a comparison of said analysis for one supplier against similar analysis for one or more other suppliers.

6. The system of claim 1, further comprising a means to automatically attempt to determine which supplier was selected by said customer.

7. The system of claim 1, wherein said customer selects one or more of said inquiries.

8. The system of claim 1, further comprising a means to update said inquiries stored in said first database.

9. The system of claim 1, further comprising a means to update said analysis stored in said second database.

10. A method for evaluating supplier competence and abilities, said method comprising the steps of:
(a) transmitting a set of inquiries to one or more raters over an electronic network;
(b) collecting and storing said raters' responses to said inquiries in an electronic database;
(c) using an encrypting means to separate certain of said stored responses from the identity of the rater who provided said response;
(d) compiling and processing said stored responses with a data processor to create a supplier analysis; and
(e) communicating said analysis to a customer.

11. The method of claim 10, further comprising the step of automatically attempting to determine which supplier was selected by said customer.

12. The method of claim 10, further comprising the step of updating said supplier analysis.
